(19) United States
(12) Patent Application Publication
(10) Pub. No.: US 2026/0134001 A1
(43) Pub. Date: May 14, 2026

(54) HUMAN-COMPUTER INTERACTION METHOD, ELECTRONIC DEVICE, AND STORAGE MEDIUM

(71) Applicant: Beijing Baidu Netcom Science Technology Co., Ltd., Beijing (CN)

(72) Inventors: Haifeng WANG, Beijing (CN); Xiaoguang HU, Beijing (CN); Dianhai YU, Beijing (CN); Yanjun MA, Beijing (CN); Tian WU, Beijing (CN)

(21) Appl. No.: 18/846,567

(22) PCT Filed: Jun. 14, 2024
(86) PCT No.: PCT/CN2024/099252

§ 371 Date: Sep. 12, 2024

(30) Foreign Application Priority Data
Oct. 31, 2023 (CN) 202311433823.9

(51) Int. Cl. G06F 16/3329; G06F 16/334

(52) U.S. Cl. CPC G06F 16/3329; G06F 16/3347

(57) ABSTRACT

A human-computer interaction method, a human-computer interaction apparatus, an electronic device and a storage medium are provided, which relate to a field of artificial intelligence technology, and in particular to fields of deep learning, natural language processing and large model technologies. The human-computer interaction method includes: determining, in response to a human-computer interaction request, a first target plug-in related to a first dialogue text contained in the human-computer interaction request from a plurality of plug-ins registered in a large language model based on the first dialogue text contained in the human-computer interaction request; obtaining a second dialogue text based on the first dialogue text and a description text of the first target plug-in; and inputting the second dialogue text into the large language model to obtain a response text.

### CROSS REFERENCE TO RELATED APPLICATION(S)

This application is a Section 371 National Stage Application of International Application No. PCT/CN 2024/099252, filed on Jun. 14, 2024, entitled “HUMAN-COMPUTER INTERACTION METHOD AND APPARATUS, ELECTRONIC DEVICE, AND STORAGE MEDIUM”, and claims priority to Chinese Patent Application No. 202311433823.9 filed on Oct. 31, 2023, which is incorporated herein by reference in its entirety.

### TECHNICAL FIELD

The present disclosure relates to a field of artificial intelligence technology, in particular to fields of deep learning, natural language processing and large model technologies, and more specifically to a human-computer interaction method, an electronic device and a storage medium.

### BACKGROUND

A dialogue system based on a large language model is an intelligent system constructed using deep learning and natural language processing technologies, which may simulate human dialogues. By learning and being trained with a large amount of text data, the dialogue system based on the large language model may capture nuances in natural language and better understand user inputs, thereby generating more natural responses.

### SUMMARY

The present disclosure provides a human-computer interaction method, an electronic device, and a storage medium.

According to an aspect of the present disclosure, a human-computer interaction method is provided, including: determining, in response to a human-computer interaction request, a first target plug-in related to a first dialogue text contained in the human-computer interaction request from a plurality of plug-ins registered in a large language model based on the first dialogue text contained in the human-computer interaction request; obtaining a second dialogue text based on the first dialogue text and a description text of the first target plug-in; and inputting the second dialogue text into the large language model to obtain a response text.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method described above.

According to another aspect of the present disclosure, a non-transitory computer-readable storage medium having computer instructions therein is provided, and the computer instructions are configured to cause a computer to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 schematically shows an exemplary system architecture to which a human-computer interaction method and a human-computer interaction apparatus may be applied according to embodiments of the present disclosure;

FIG. 2 schematically shows a flowchart of a human-computer interaction method according to embodiments of the present disclosure;

FIG. 3A schematically shows a schematic diagram of a matching process for a first target plug-in according to embodiments of the present disclosure;

FIG. 3B schematically shows a schematic diagram of a matching process for a first target plug-in according to other embodiments of the present disclosure;

FIG. 4A schematically shows a schematic diagram of a process of generating a response text according to embodiments of the present disclosure;

FIG. 4B schematically shows a schematic diagram of a process of generating a response text according to other embodiments of the present disclosure;

FIG. 5 schematically shows a flowchart of a human-computer interaction method according to other embodiments of the present disclosure;

FIG. 6 schematically shows a block diagram of a human-computer interaction apparatus according to embodiments of the present disclosure; and

FIG. 7 shows a schematic block diagram of an example electronic device that may be used to implement embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

With a continuous development of artificial intelligence technology, dialogue systems as one of important application fields have been widely used in human-computer interaction, intelligent customer service, intelligent assistants and other fields. As an important part of a dialogue system, a large language model plays a vital role in the dialogue system.

An implementation of the large language model mainly relies on deep learning technology and natural language processing technology. The deep learning technology may be used to learn and train with input text data through a multi-layer neural network and a back propagation algorithm, so as to obtain an output result. The natural language processing technology may be used to process and understand input natural language through processing and analysis of text data, so as to achieve a function of the dialogue system.

In practical applications, large language models have a common defect of artificial neural networks, that is, it is difficult to accurately answer a question about new data outside a training dataset. To address the defect, technicians have begun to configure plug-ins for the large language model. The plug-ins may act as “eyes and ears” of the large language model, which allow the large language model to access new private or specific information that is not contained in the training data, so that the large language model may better serve users. Moreover, the plug-ins may be combined with powerful content generation ability and context understanding ability of the large language model to broaden application fields of the large language model and increase credibility of generated results. In addition, plug-ins may enable the large language model to perform secure and restricted operations on behalf of the plug-ins, thereby improving practicality of the entire system.

In relevant plug-in management methods, a user needs to manually select a desired plug-in. When the user conducts a dialogue, a dialogue system may input the plug-in selected by the user into the large language model in the form of a prompt word by means of a plug-in description, that is, insert the plug-in description of the plug-in selected by the user into a context of a dialogue content input by the user, and then input a processed dialogue content into the large language model. The large language model may determine which plug-in is needed for a current input dialogue content, and then call a corresponding plug-in to complete a relevant function.

As the number of plug-ins configured in the large language model increases, for example, tens of thousands of plug-ins may be configured, it may be difficult for the user to select a desired plug-in at a low cost. Moreover, when a dialogue system based on large language model conducts multiple rounds of dialogue with the user, an input dialogue content and an output response content of a historical dialogue may be added to a context of a subsequent dialogue, so that a dialogue content in a new round of dialogue may have a long context. If respective plug-in descriptions of a plurality of plug-ins selected by the user are all inserted into the context of the dialogue content input by the user, the text actually input into the large language model may be too long, and even exceed a limit of the number of tokens of the large language model for the input content, which may increase a processing time length of the large language model and reduce an accuracy of the output response content.

In view of this, embodiments of the present disclosure provide a human-computer interaction method, a human-computer interaction apparatus, an electronic device, and a storage medium to at least partially solve the above problems. The human-computer interaction method includes: determining, in response to a human-computer interaction request, a first target plug-in related to a first dialogue text contained in the human-computer interaction request from a plurality of plug-ins registered in a large language model based on the first dialogue text contained in the human-computer interaction request; obtaining a second dialogue text based on the first dialogue text and a description text of the first target plug-in; and inputting the second dialogue text into the large language model to obtain a response text.

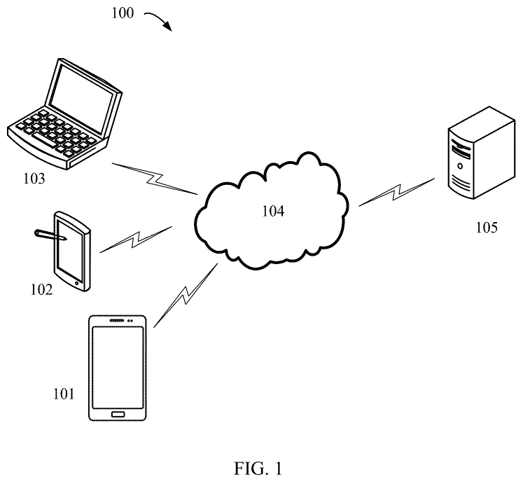

FIG. 1 schematically shows an exemplary system architecture to which a human-computer interaction method and a human-computer interaction apparatus may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which the human-computer interaction method and the human-computer interaction apparatus may be applied may include a terminal device, but the terminal device may implement the human-computer interaction method and the human-computer interaction apparatus without interacting with a server.

As shown in FIG. 1, the system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, etc.

The terminal devices 101, 102 and 103 may be various electronic devices having display screens and supporting web browsing, including but not limited to smart phones, tablet computers, laptop computers, and desktop computers, etc.

The terminal devices 101, 102 and 103 may be installed with a client application of a dialogue system, and the dialogue system may be a dialogue system based on large language model. The large language model may be used by a user to perform text processing through the client application on the terminal devices 101, 102 and 103.

The server 105 may be a server or a cloud server that provides various services. A backend application of the dialog system may be installed on the server 105.

It should be noted that the human-computer interaction method provided in embodiments of the present disclosure may generally be performed by the terminal device 101, 102 or 103. Accordingly, the human-computer interaction apparatus provided in embodiments of the present disclosure may be arranged in the terminal device 101, 102 or 103.

Alternatively, the human-computer interaction method provided in embodiments of the present disclosure may generally be performed by the server 105. Accordingly, the human-computer interaction apparatus provided in embodiments of the present disclosure may generally be arranged in the server 105. The human-computer interaction method provided in embodiments of the present disclosure may also be performed by a server or server cluster different from the server 105 and capable of communicating with the terminal devices 101, 102, 103 and/or the server 105. Accordingly, the human-computer interaction apparatus provided in embodiments of the present disclosure may also be arranged in a server or server cluster different from the server 105 and capable of communicating with the terminal devices 101, 102, 103 and/or the server 105.

It should be understood that the number of terminal devices, network and server shown in FIG. 1 is merely schematic. According to implementation needs, any number of terminal devices, networks and servers may be provided.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

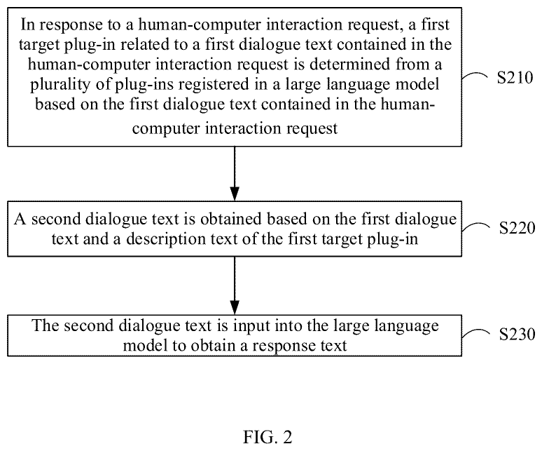

FIG. 2 schematically shows a flowchart of a human-computer interaction method according to embodiments of the present disclosure.

As shown in FIG. 2, the method includes operation S210 to operation S230.

In operation S210, in response to a human-computer interaction request, a first target plug-in related to a first dialogue text contained in the human-computer interaction request is determined from a plurality of plug-ins registered in a large language model based on the first dialogue text contained in the human-computer interaction request.

In operation S220, a second dialogue text is obtained based on the first dialogue text and a description text of the first target plug-in.

In operation S230, the second dialogue text is input into the large language model to obtain a response text.

According to embodiments of the present disclosure, the human-computer interaction request may be triggered when the dialogue system is used by a user to conduct a dialogue. The dialogue system may be configured with an information input interface such as a text input control, an audio input control, etc. For example, a dialogue text may be input by the user in a text box contained in the text input control. After the input of the dialogue text is completed, a send button contained in the text input control may be clicked by the user to input the dialogue text into the dialogue system. The dialogue system may trigger the human-computer interaction request when receiving the dialogue text. For another example, a dialogue button contained in the audio input control may be pressed by the user, and an audio information may be input by the user through an audio receiving device configured on an electronic device installed with the dialogue system. The input audio information may be converted into a dialogue text through natural language processing. After the dialogue button is released by the user, the dialogue text obtaining by converting the audio information may be input into the dialogue system. The dialogue system may trigger the human-computer interaction request when receiving the dialogue text. The dialogue system described above may be a dialogue system based on large language model, in which the received dialogue text may be processed using a large language model.

According to embodiments of the present disclosure, the first dialogue text is the dialogue text received by the dialogue system when the human-computer interaction request is triggered.

According to embodiments of the present disclosure, a developer may pre-register a plurality of plug-ins for the large language model. After the registration of the plug-ins is completed, the large language model may call a plug-in using a description text of the plug-in. The description text of the plug-in may include, for example, a functional description text of the plug-in, a usage example of the plug-in, etc. The functional description text may be used to explain a function of the plug-in. For example, in a case of a weather query plug-in, the functional description text of the plug-in may be, for example, “the plug-in may output weather conditions according to the city and date input by the user.” The usage example of the plug-in may include but not be limited to a correct usage example and an incorrect usage example of the plug-in. Each usage example may include at least a form of an input text of a user and a form of an output text of the large language model. For example, in a case of a weather query plug-in, the usage example of the weather query plug-in may be “input: what's the weather like in city A on C/D/B (month/day/year); output: it's sunny in city A on C/D/B (month/day/year), the temperature is E ° C, the relative humidity is F %, and the wind force level is G”. The large language model calling the plug-in to process the dialogue text may specifically include adjusting the dialogue text to the same text form as the input in the usage example, and then processing the adjusted dialogue text using the plug-in to obtain the output text of the plug-in.

According to embodiments of the present disclosure, determining the first target plug-in from the plurality of plug-ins may include, for example, matching the dialog text with the text of the input part in the usage example contained in the description text of the plug-in, and determining a plug-in with a highest matching degree as the first target plug-in.

According to embodiments of the present disclosure, the second dialogue text may be obtained by concatenating the first dialogue text and the description text of the first target plug-in. Alternatively, it is possible to fill the first dialogue text and the description text of the first target plug-in into a same text template to obtain the second dialogue text. Alternatively, it is possible to perform a text reconstruction on the first dialogue text and the description text of the first target plug-in using the large language model, so as to obtain the second dialogue text. The second dialogue text may include a text content of the first dialogue text, a feature information of the first dialogue text, a text content of the description text of the first target plug-in, and a feature information of the description text of the first target plug-in. The second dialogue text may be used as a text actually input into the large language model.

According to embodiments of the present disclosure, as an optional implementation, it is also possible to detect, in response to the human-computer interaction request, whether the first dialogue text is implementable using a function of the large language model per se. If it is determined that the first dialogue text is implementable using a function of the large language model per se, the first dialogue text may be processed directly using the large language model to obtain a response text. If it is determined that the first dialogue text is not implementable using a function of the large language model per se, it is possible to match the most appropriate first target plug-in by using the text content of the first dialogue text, and then generate a response text by using a function of the first target plug-in.

According to embodiments of the present disclosure, when a new dialogue text is input into the dialogue system by the user to trigger a human-computer interaction request, it is possible to obtain the most relevant first target plug-in from the plurality of registered plug-ins according to the text content of the first dialogue text, and input the second dialogue text, which is obtained by fusing the first dialogue text and the description text of the first target plug-in, into the large language model to obtain a response text corresponding to the first dialogue text. By matching a plug-in with the text content of the first dialogue text, it is not needed for the user to actively select a desired plug-in during the dialogue, so that a user experience may be effectively improved. Moreover, by filtering plug-ins, the dialogue system does not need to concatenate excessive plug-in description text in the context of the dialogue text, so that a length of the text actually input into the large language model may be effectively reduced, and a processing efficiency and an accuracy of the large language model may be improved.

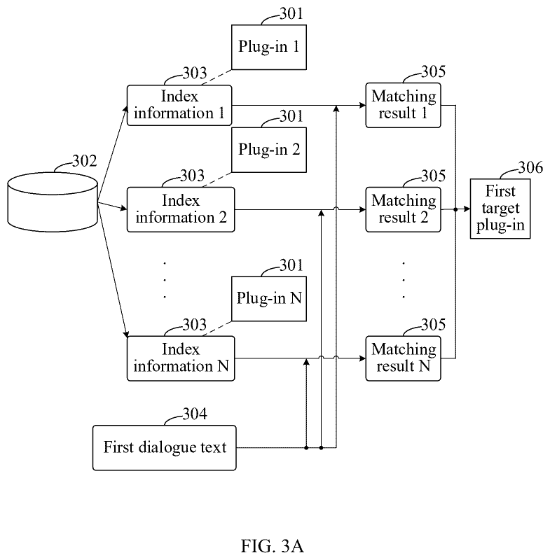

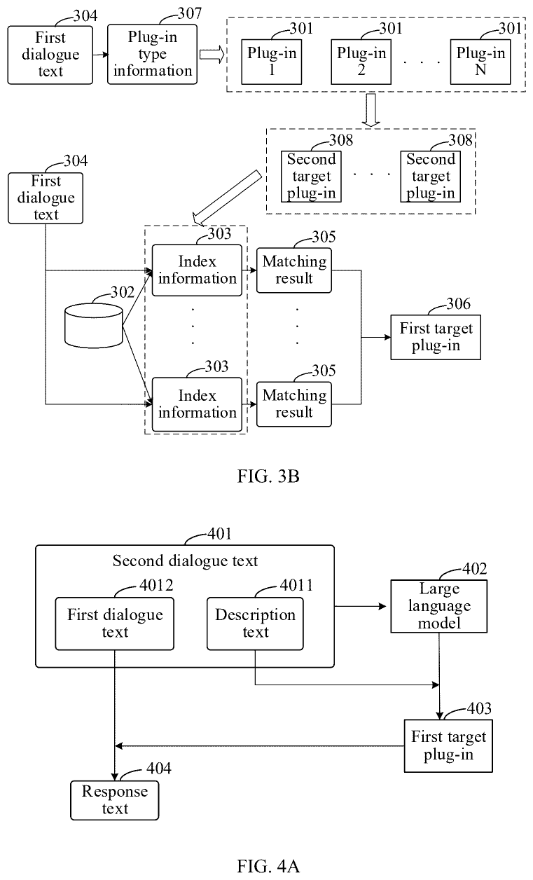

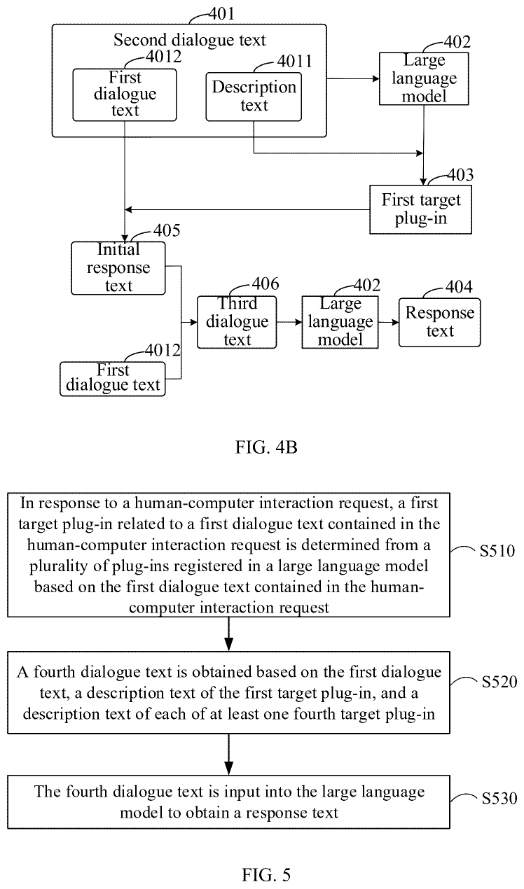

The method shown in FIG. 2 will be further described below in conjunction with specific embodiments with reference to FIG. 3A to FIG. 3B, FIG. 4A to FIG. 4B and FIG. 5.

According to embodiments of the present disclosure, in order to perform the calling of the plug-in by the large language model, it is needed to register the plug-in in the large language model. When registering a plug-in, it is possible to create an index based on a description of the plug-in, and then in a human-computer interaction, the plug-in matching may be performed based on the index.

According to embodiments of the present disclosure, taking the plug-in to be registered being a third target plug-in as an example, a plug-in registration process may include the following operations. In response to a plug-in registration request, an index information of a third target plug-in is generated based on a description text of the third target plug-in contained in the plug-in registration request; and the index information of the third target plug-in is written into a plug-in information database.

According to embodiments of the present disclosure, the plug-in registration request may be actively triggered by the user. Specifically, the third target plug-in to be registered may be imported by the user into the dialogue system through a command line instruction, a plug-in registration control on a front-end page of the dialogue system, etc., and then the plug-in registration request may be triggered by the user.

According to embodiments of the present disclosure, the form of the index information of the plug-in is not limited here. For example, the index information of the plug-in may include one or more keywords that may be extracted from the description text of the plug-in. For another example, the index information of the plug-in may be represented as a vector, which may be a feature vector obtained based on the description text of the plug-in.

According to embodiments of the present disclosure, the plug-in information database may be any type of database, or the plug-in information database may also be represented as a data structure in other forms, which is not limited here.

According to embodiments of the present disclosure, corresponding to the plug-in registration process, the plug-in matching may also be performed by using the respective index information of the plug-ins in the plug-in information database in the matching process for the plug-in. Specifically, determining the first target plug-in related to the first dialogue text contained in the human-computer interaction request from the plurality of plug-ins registered in the large language model based on the first dialogue text contained in the human-computer interaction request may include the following operations. The respective index information of the plurality of plug-ins is acquired from the plug-in information database; the first dialogue text is matched with the respective index information of the plurality of plug-ins to obtain a plurality of matching results; and the first target plug-in is determined from the plurality of plug-ins based on the plurality of matching results.

FIG. 3A schematically shows a schematic diagram of a matching process for a first target plug-in according to embodiments of the present disclosure.

As shown in FIG. 3A, the large language model may be configured with N registered plug-ins 301, which may be represented as plug-in 1, plug-in 2, . . . , plug-in N. N index information 303 respectively corresponding to the N plug-ins 301 may be recorded in a plug-in information database 302. For example, N index information 303 may include index information 1 corresponding to plug-in 1, index information 2 corresponding to plug-in 2, index information N corresponding to plug-in N, etc.

According to embodiments of the present disclosure, the first dialogue text 304 may be matched with the N index information 303 to obtain N matching results 305. For example, it is possible to match the first dialogue text 304 with the index information I to obtain a matching result 1, match the first dialogue text 304 with the index information 2 to obtain a matching result 2, and so on.

According to embodiments of the present disclosure, the N matching results 305 may all be expressed as numerical values in a fixed interval, and a matching probability represented by the matching result has a fixed corresponding relationship with a size of the numerical value of the matching result based on a calculation method of the matching result. For example, the N matching results may all range from 0 to 1, and the closer the numeric value of the matching result is to 1, the higher the matching degree between the first dialogue text and the plug-in indicated by the matching result. Determining the first target plug-in 306 based on the N matching results includes comparing sizes of the N matching results to determine the matching result having a largest numeric value, and the plug-in corresponding to the matching result having the largest numeric value is the first target plug-in 306.

According to embodiments of the present disclosure, a specific calculation method of the matching result may be related to a generation method and a form of the index information in the plug-in registration.

For example, in the plug-in registration, it is possible to perform a feature extraction on the description text of the plug-in to obtain a feature vector of the description text, and generate the index information of the plug-in based on the feature vector, that is, the index information of the plug-in may include the feature vector of the description text of the plug-in. Matching the first dialogue text with the respective index information of the plurality of plug-ins to obtain the plurality of matching results may include the following operations. A feature extraction is performed on the first dialogue text to obtain a feature vector of the first dialogue text; similarities between the feature vector of the first dialogue text and the feature vectors of the respective description texts of the plurality of plug-ins are calculated to obtain a plurality of similarity calculation results; and the plurality of matching results are obtained based on the plurality of similarity calculation results.

According to embodiments of the present disclosure, the similarity calculation may be performed using any method of calculating similarity between vectors, which may include but not be limited to a cosine similarity calculation method, a correlation coefficient method, and the like.

According to embodiments of the present disclosure, the larger the numerical value of the similarity calculation result, the higher the similarity between the feature vector of the first dialogue text and the feature vector of the description text of the corresponding plug-in, and the higher the matching degree indicated by the corresponding matching result.

For another example, in the plug-in registration, a keyword extraction may be performed on the description text of the plug-in to obtain at least one keyword of the description text, and the index information of the plug-in may be generated based on the at least one keyword, that is, the index information of the plug-in may include at least one keyword related to the description text of the plug-in. Matching the first dialogue text with the respective index information of the plurality of plug-ins to obtain the plurality of matching results may include the following operations. A keyword extraction is performed on the first dialogue text to obtain a keyword related to the first dialogue text; and the keyword related to the first dialogue text is matched with at least one keyword related to the description text of each of the plurality of plug-ins to obtain the plurality of matching results.

According to embodiments of the present disclosure, a similarity between the index information of the plug-in and the first dialog text may be determined according to the number of hit keywords, that is, the matching result may be expressed as the number of hit keywords. For example, it is possible to perform a keyword extraction on the description text of plug-in α to obtain keyword a, keyword b, keyword, and keyword d. Similarly, a keyword extraction may be performed on the first dialogue text to obtain keyword b, keyword d, and keyword e. As the plug-in o and the first dialogue text both include keyword b and keyword d. the matching result obtained by matching the first dialogue text with the plug-in α may be expressed as 2.

According to embodiments of the present disclosure, by providing an index information for a plug-in in the plug-in registration, it is possible to achieve a fast plug-in matching based on the index information in the matching process for the plug-in, so that an accuracy of the plug-in matching may be effectively improved, and an efficiency of the plug-in matching operation may be improved.

According to embodiments of the present disclosure, the plug-ins may be used to process respective types of questions. For example, plug-in I may be used to process a mathematical calculation question, plug-in 2 may be used to process a weather query question, and so on. The plurality of registered plug-ins may be grouped based on the problems that may be processed. For example, a weather query plug-in, a humidity query plug-in, etc. are used to process problems of how to query climate, and therefore, the weather query plug-in and the humidity query plug-in may be classified into the same category, and a plug-in type of the weather query plug-in and a plug-in type of the humidity query plug-in may be determined as climate plug-ins.

According to embodiments of the present disclosure, as an optional implementation, the plug-in information database may contain a large amount of index information, and the plug-in matching based on the index information may still require a considerable amount of time. Therefore, before performing the plug-in matching based on the index information, it is possible to preliminarily filter the plug-ins based on plug-in types.

FIG. 3B schematically shows a schematic diagram of a matching process for a first target plug-in according to other embodiments of the present disclosure.

As shown in FIG. 3B, N registered plug-ins 301 may be configured in the large language model, and N index information 303 respectively corresponding to the N plug-ins 301 may be recorded in the plug-in information database 302.

According to embodiments of the present disclosure, a plug-in type information 307 related to the first dialog text 304 may be determined based on the first dialog text 304. At least one second target plug-in 308 may be determined from the N plug-ins 301 based on the plug-in type information 307. That is, the plug-in type of each of the at least one second target plug-in 308 is the same as a plug-in type represented by the plug-in type information 307. After the at least one second target plug-in 308 is determined, index information 303 of each of the at least one second target plug-in 308 may be acquired from the plug-in information database 302. The first dialogue text 304 is matched with the index information 303 of each of the at least one second target plug-in 308 to obtain at least one matching result 305. The first target plug-in 306 may be determined from the at least one second target plug-in 308 based on the at least one matching result 305.

According to embodiments of the present disclosure, the matching process for the at least one second target plug-in and the process of determining the first target plug-in from the at least one second target plug-in may be implemented using the matching method for the plurality of plug-ins and the method of determining the first target plug-in from the plurality of plug-ins described above, which will not be repeated here.

According to embodiments of the present disclosure, by preliminarily filtering the plug-ins based on the plug-in types before performing the plug-in matching based on the index information, it is possible to effectively reduce computing resources consumed by the plug-in matching process and improve the processing efficiency.

According to embodiments of the present disclosure, after the first target plug-in is determined, the text actually input into the large language model, i.e., the second dialog text, may be obtained based on the first dialog text and the description text of the first target plug-in.

According to embodiments of the present disclosure, the second dialogue text may be generated by direct concatenation based on the first dialogue text and the description text of the first target plug-in, that is, the second dialogue text may be obtained by concatenating the description text of the first target plug-in into the context of the first dialogue text.

According to embodiments of the present disclosure, for example, the first dialogue text may be “please calculate a result of 256 times 4”. The first target plug-in matched with the first dialogue text may be a mathematical calculation plug-in, and the description text of the mathematical calculation plug-in may be “a mathematical calculation plug-in that may input an expression consisting of numbers and operators and output a calculation result”. The description text of the first target plug-in may be concatenated into the context of the first dialogue text to obtain a second dialogue text expressed as “a mathematical calculation plug-in that may input an expression consisting of numbers and operators and output a calculation result. Please calculate a result of 256 times 4”.

According to embodiments of the present disclosure, the second dialogue text may also be generated based on the first dialogue text and the description text of the first target plug-in by using a template-based concatenation method, that is, the second dialogue text may be obtained by separately filling the first dialogue text and the description text of the first target plug-in into a first prompt template.

According to embodiments of the present disclosure, the first prompt template may be a text template set by a user, which has one or more replaceable text paragraphs and a language expression form suitable for being input into the large language model. The replaceable text paragraph may be represented as an information slot in the first prompt template. For example, the first prompt template may include two information slots, namely a first text information slot and a plug-in information slot. The first text information slot is suitable for filling in the dialog text input by the user, and the plug-in information slot is suitable for filling in the description text of the plug-in. The second dialogue text generated based on the first prompt template may be used to guide the large language model to call the plug-in and process the text.

According to embodiments of the present disclosure, for example, the first prompt template may be expressed as “the following plug-in is available to answer questions: [insert text 1]. The following question is given: [insert text 2]”. In the first prompt template, “[insert text]1” represents the plug-in information slot, and “[insert text 2]” represents the first text information slot. The first dialogue text may be “please calculate a result of 256 times 4”. The first target plug-in matched with the first dialogue text may be a mathematical calculation plug-in, and the description text of the mathematical calculation plug-in may be “a mathematical calculation plug-in that may input an expression consisting of numbers and operators and output a calculation result”. The first dialogue text may be filled into the first text information slot, and the description text of the first target plug-in may be filled into the plug-in information slot, so as to obtain the second dialogue text. The second dialogue text obtained may be expressed as “the following plug-in is available to answer questions: a mathematical calculation plug-in that may input an expression consisting of numbers and operators and output a calculation result. The following question is given: please calculate a result of 256 times 4”.

According to embodiments of the present disclosure, after the second dialogue text is generated, the large language model may call the first target plug-in to process the second dialogue text, so as to obtain the response text.

According to embodiments of the present disclosure, the output text obtained by processing the second dialogue text using the first target plug-in may be a text with actual meaning or specific meaning. The output text may be directly used as the response text of the large language model. That is, the second dialogue text may be input into the large language model, so that the large language model may call the first target plug-in based on the description text of the first target plug-in contained in the second dialogue text to process the first dialogue text contained in the second dialogue text, so as to obtain the response text.

FIG. 4A schematically shows a schematic diagram of a process of generating a response text according to embodiments of the present disclosure.

As shown in FIG. 4A, a second dialogue text 401 may be input into a large language model 402. The large language model may call a first target plug-in 403 based on a description text 4011 contained in the second dialogue text 401 to process a first dialogue text 4012 contained in the second dialogue text 401. A processing result of the first target plug-in 403 is a response text 404 of the large language model 402.

For example, the second dialogue text may be expressed as “the following plug-in is available to answer questions: a mathematical calculation plug-in that may input an expression consisting of numbers and operators and output a calculation result. The following question is given: please calculate a result of 256 times 4”. After the second dialogue text is input into the large language model, the large language model may determine that the plug-in to be called is the mathematical calculation plug-in, based on the description text “a mathematical calculation plug-in that may input an expression consisting of numbers and operators and output a calculation result” contained in the second dialogue text, and then process the first dialogue text “please calculate a result of 256 times 4” contained in the second dialogue text by using the mathematical calculation plug-in. After the processing, an output text “1024” may be obtained, and the output text may be directly used as the response text of the large language model.

According to embodiments of the present disclosure, as an optional implementation, the processing result output by the first target plug-in may be further input into the large language model, so as to output a response text that has a form closer to a human expression form by using a text processing ability of the large language model. For example, the second dialogue text may be input into the large language model, so that the large language model may call the first target plug-in based on the description text of the first target plug-in contained in the second dialogue text to process the first dialogue text contained in the second dialogue text, so as to obtain an initial response text; a third dialogue text may be obtained based on the first dialogue text and the initial response text; and the third dialogue text may be input into the large language model to obtain the response text.

FIG. 4B schematically shows a schematic diagram of a process of generating a response text according to other embodiments of the present disclosure.

As shown in FIG. 4B, the second dialogue text 401 may be input into the large language model 402. The large language model may call the first target plug-in 403 based on the description text 4011 contained in the second dialogue text 401 to process the first dialogue text 4012 contained in the second dialogue text 401, so as to obtain an initial response text 405. The initial response text 405 may be fused with the first dialogue text 4012 to obtain a third dialogue text 406. Specifically, the first dialogue text 4012 and the initial response text 405 may be separately filled into a second prompt template to obtain the third dialogue text 406. Then, the third dialogue text 406 may be input into the large language model 402 to obtain the response text 404.

According to embodiments of the present disclosure, similar to the first prompt template, the second prompt template may also include a plurality of information slots. For example, the second prompt template may include two information slots, which may be represented as a second text information slot and a third text information slot respectively. It should be noted that the second prompt template may also include more than two information slots, which is not limited here.

According to embodiments of the present disclosure, filling the first dialogue text 4012 and the initial response text 405 separately into the second prompt template to obtain the third dialogue text 406 may specifically include filling the first dialogue text 4012 into the second text information slot and filing the initial response text 405 into the third text information slot, so as to obtain the third dialogue text 406.

For example, the second prompt template may be expressed as “the question may be answered based on the following information: [insert text 3]. The following question is given: [insert text 4]”. The information slot “[insert text 3]” may represent the third text information slot, and the information slot “[insert text 4]” may represent the second text information slot. The first dialogue text may be expressed as “please calculate a result of 256 times 4”, and the initial response text may be expressed as “1024”. After the first dialogue text and the initial response text are filled into the second prompt template, the third dialogue text obtained may be expressed as “the question may be answered based on the following information: 1024. The following question is given: please calculate a result of 256 times 4”. After the third dialogue text is input into the large language model, the response text obtained may be expressed as “a calculation result of 256 times 4 is 1024”.

According to embodiments of the present disclosure, with the help of an understanding ability of the large language model, it is possible to call the corresponding plug-in based on the description text of the plug-in to process a task that the large language model may not process, so that the usability and universality of the large language model may be effectively improved, and there is no need to retrain the large language model when facing different tasks, thereby reducing the cost of use of the large language model.

According to embodiments of the present disclosure, as an optional implementation, the user is allowed to manually select a plug-in to indicate that the large language model may process the dialogue text using the selected plug-in, that is, the user is allowed to specify that a description text of a plug-in needs to be added to the context of the dialogue text. In this case, the text actually input into the large language model may include the first dialogue text, the description text of the plug-in autonomously selected by the dialogue system, and the description text of the plug-in manually selected by the user.

According to embodiments of the present disclosure, a manual select operation of the user may be used to change a selected state mark of a plug-in. For example, the user is allowed to manually select at least one fourth target plug-in. Correspondingly, the plurality of plug-ins may include at least one fourth target plug-in, and the at least one fourth target plug-in may be marked as selected.

FIG. 5 schematically shows a flowchart of a human-computer interaction method according to other embodiments of the present disclosure.

As shown in FIG. 5, the method includes operation S510 to operation S530.

In operation S510, in response to a human-computer interaction request, a first target plug-in related to a first dialogue text contained in the human-computer interaction request is determined from a plurality of plug-ins registered in a large language model based on the first dialogue text contained in the human-computer interaction request.

In operation S520, a fourth dialogue text is obtained based on the first dialogue text, a description text of the first target plug-in, and a description text of each of at least one fourth target plug-in.

In operation S530, the fourth dialogue text is input into the large language model to obtain a response text.

According to embodiments of the present disclosure, the method of determining the first target plug-in from the plurality of plug-ins may refer to the matching process for the first target plug-in described above, which will not be described in detail here.

According to embodiments of the present disclosure, the method of obtaining the fourth dialogue text based on the first dialogue text, the description text of the first target plug-in and the description text of each of the at least one fourth target plug-in may refer to the method of generating the second dialogue text described above, in which the description text of the first target plug-in is replaced with the description text of the first target plug-in and the description text of each of the at least one fourth target plug-in, and the second dialogue text is replaced with the fourth dialogue text, which will not be described in detail here.

According to embodiments of the present disclosure, in the process of generating the response text, it is possible to further determine at least one matching result obtained by matching the first dialogue text with the at least one fourth target plug-in. Based on the at least one matching result, it may be determined whether the plug-in actually used to process the first dialogue text is the first target plug-in autonomously selected by the dialogue system or the plug-in selected by the user. That is, the fourth dialogue text may be input into the large language model, so that the large language model may determine the fourth target plug-in from the first target plug-in and the at least one fourth target plug-in based on the fourth dialogue text; and the large language model may call the fourth target plug-in based on the description text of the fourth target plug-in contained in the fourth dialogue text to process the first dialogue text contained in the fourth dialogue text, so as to obtain the response text. The process of obtaining the response text using the fourth dialogue text may refer to the process of generating the response text described above, which will not be repeated here. The method used for matching the first dialogue text with the at least one fourth target plug-in may be different from the method used for matching the first dialogue text with the plurality of plug-ins. Furthermore, a correction coefficient may be added to the matching result of the fourth target plug-in. The correction coefficient may be a value greater than 1, so that the large language model may use the plug-in selected by the user as much as possible to perform text processing.

According to embodiments of the present disclosure, by adding both the description text of the plug-in autonomously selected by the dialogue system and the description text of the plug-in selected by the user to the context of the dialogue text, it is possible to ensure a tendency of the large language model in text processing while improving the user experience, so that the response text output by the large language model may be more in line with a user intention, thereby improving the usability of the dialogue system.

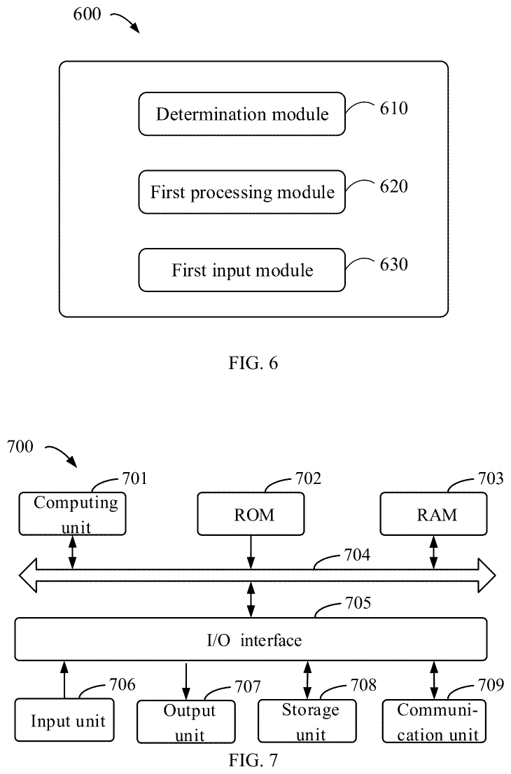

FIG. 6 schematically shows a block diagram of a human-computer interaction apparatus according to embodiments of the present disclosure.

As shown in FIG. 6, a human-computer interaction apparatus 600 includes a determination module 610, a first processing module 620, and a first input module 630.

The determination module 610 is used to determine, in response to a human-computer interaction request, a first target plug-in related to a first dialogue text contained in the human-computer interaction request from a plurality of plug-ins registered in a large language model based on the first dialogue text contained in the human-computer interaction request.

The first processing module 620 is used to obtain a second dialogue text based on the first dialogue text and a description text of the first target plug-in.

The first input module 630 is used to input the second dialogue text into the large language model to obtain a response text.

According to embodiments of the present disclosure, the determination module 610 includes a first determination unit, a second determination unit, and a third determination unit.

The first determination unit is used to acquire an index information of each of the plurality of plug-ins from a plug-in information database.

The second determination unit is used to match the first dialogue text with the index information of each of the plurality of plug-ins to obtain a plurality of matching results.

The third determination unit is used to determine the first target plug-in from the plurality of plug-ins based on the plurality of matching results.

According to embodiments of the present disclosure, the index information of each of the plurality of plug-ins includes a feature vector of a description text of the each of the plurality of plug-ins.

According to embodiments of the present disclosure, the second determination unit includes a first determination sub-unit, a second determination sub-unit, and a third determination sub-unit.

The first determination sub-unit is used to perform a feature extraction on the first dialogue text to obtain a feature vector of the first dialogue text.

The second determination sub-unit is used to calculate a similarity between the feature vector of the first dialogue text and the feature vector of the description text of each of the plurality of plug-ins to obtain a plurality of similarity calculation results.

The third determination sub-unit is used to obtain the plurality of matching results based on the plurality of similarity calculation results.

According to embodiments of the present disclosure, the index information of each of the plurality of plug-ins includes at least one keyword related to the description text of the each of the plurality of plug-ins.

According to embodiments of the present disclosure, the second determination unit includes a fourth determination sub-unit and a fifth determination sub-unit.

The fourth determination sub-unit is used to perform a keyword extraction on the first dialogue text to obtain a keyword related to the first dialogue text.

The fifth determination sub-unit is used to match the keyword related to the first dialogue text with at least one keyword related to the description text of each of the plurality of plug-ins to obtain the plurality of matching results.

According to embodiments of the present disclosure, the determination module 610 includes a fourth determination unit, a fifth determination unit, a sixth determination unit, a seventh determination unit, and an eighth determination unit The fourth determination unit is used to determine, based on the first dialogue text, a plug-in type information related to the first dialogue text.

The fifth determination unit is used to determine at least one second target plug-in from the plurality of plug-ins based on the plug-in type information.

The sixth determination unit is used to acquire an index information of each of the at least one second target plug-in from a plug-in information database.

The seventh determination unit is used to match the first dialogue text with the index information of each of the at least one second target plug-in to obtain at least one matching result.

The eighth determination unit is used to determine the first target plug-in from the at least one second target plug-in based on the at least one matching result.

According to embodiments of the present disclosure, the human-computer interaction apparatus 600 further includes a generation module and a writing module.

The generation module is used to generate, in response to a plug-in registration request, an index information of a third target plug-in based on a description text of the third target plug-in contained in the plug-in registration request.

The writing module is used to write the index information of the third target plug-in into the plug-in information database.

According to embodiments of the present disclosure, the first processing module 620 includes a first processing unit.

The first processing unit is used to concatenate the description text of the first target plug-in into a context of the first dialogue text to obtain the second dialogue text.

According to embodiments of the present disclosure, the first processing module 620 includes a second processing unit.

The second processing unit is used to fill the first dialogue text and the description text of the first target plug-in separately into a first prompt template to obtain the second dialogue text.

According to embodiments of the present disclosure, the first prompt template includes a first text information slot and a plug-in information slot.

According to embodiments of the present disclosure, the second processing unit includes a processing sub-unit.

The processing sub-unit is used to fill the first dialogue text into the first text information slot and fill the description text of the first target plug-in into the plug-in information slot, so as to obtain the second dialogue text.

According to embodiments of the present disclosure, the first input module 630 includes a first input unit.

The first input unit is used to input the second dialogue text into the large language model so that the large language model calls the first target plug-in based on the description text of the first target plug-in contained in the second dialogue text to process the first dialogue text contained in the second dialogue text to obtain the response text.

According to embodiments of the present disclosure, the first input module 630 includes a second input unit, a third input unit, and a fourth input unit.

The second input unit is used to input the second dialogue text into the large language model so that the large language model calls the first target plug-in based on the description text of the first target plug-in contained in the second dialogue text to process the first dialogue text contained in the second dialogue text to obtain an initial response text.

The third input unit is used to fill the first dialogue text and the initial response text separately into a second prompt template to obtain a third dialogue text.

The fourth input unit is used to input the third dialogue text into the large language model to obtain the response text.

According to embodiments of the present disclosure, the second prompt template includes a second text information slot and a third text information slot.

According to embodiments of the present disclosure, the third input unit includes an input sub-unit.

The input sub-unit is used to fill the first dialogue text into the second text information slot and fill the initial response text into the third text information slot, so as to obtain the third dialogue text.

According to embodiments of the present disclosure, the plurality of plug-ins include at least one fourth target plug-in, and the at least one fourth target plug-in is marked as being in a selected state.

According to embodiments of the present disclosure, the human-computer interaction apparatus 600 further includes a second processing module and a second input module.

The second processing module is used to obtain a fourth dialogue text based on the first dialogue text, the description text of the first target plug-in, and a description text of each of the at least one fourth target plug-in.

The second input module is used to input the fourth dialogue text into the large language model to obtain the response text.

According to embodiments of the present disclosure, the second input module includes a fifth input unit and a sixth input unit.

The fifth input unit is used to input the fourth dialogue text into the large language model so that the large language model determines a fourth target plug-in from the first target plug-in and the at least one fourth target plug-in based on the fourth dialogue text.

The sixth input unit is used to call, by using the large language model, the fourth target plug-in based on the description text of the fourth target plug-in contained in the fourth dialogue text, so as to process the first dialogue text contained in the fourth dialogue text to obtain the response text.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor, where the memory stores instructions executable by the at least one processor, and the instructions, when executed by the at least one processor, are used to cause the at least one processor to implement the method described above.

According to embodiments of the present disclosure, a non-transitory computer-readable storage medium having computer instructions therein is provided, and the computer instructions are configured to cause a computer to implement the method described above.

According to embodiments of the present disclosure, a computer program product containing a computer program is provided, and the computer program, when executed by a processor, is used to cause the processor to implement the method described above.

FIG. 7 shows a schematic block diagram of an example electronic device for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, an electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and processes described above, such as the human-computer interaction method. For example, in some embodiments, the human-computer interaction method may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the human-computer interaction method described above. Alternatively, in other embodiments, the computing unit 701 may be used to perform the human-computer interaction method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A human-computer interaction method, comprising:
determining, in response to a human-computer interaction request, a first target plug-in related to a first dialogue text contained in the human-computer interaction request from a plurality of plug-ins registered in a large language model based on the first dialogue text contained in the human-computer interaction request;
obtaining a second dialogue text based on the first dialogue text and a description text of the first target plug-in; and
inputting the second dialogue text into the large language model to obtain a response text.

2. The method according to claim 1, wherein determining the first target plug-in related to the first dialogue text contained in the human-computer interaction request from the plurality of plug-ins registered in the large language model based on the first dialogue text contained in the human-computer interaction request comprises:
acquiring an index information of each of the plurality of plug-ins from a plug-in information database;
matching the first dialogue text with the index information of each of the plurality of plug-ins to obtain a plurality of matching results; and
determining the first target plug-in from the plurality of plug-ins based on the plurality of matching results.

3. The method according to claim 2, wherein the index information of each of the plurality of plug-ins comprises a feature vector of a description text of the each of the plurality of plug-ins; and
wherein the matching the first dialogue text with the index information of each of the plurality of plug-ins to obtain a plurality of matching results comprises:
performing a feature extraction on the first dialogue text to obtain a feature vector of the first dialogue text;
calculating a similarity between the feature vector of the first dialogue text and the feature vector of the description text of each of the plurality of plug-ins to obtain a plurality of similarity calculation results; and
obtaining the plurality of matching results based on the plurality of similarity calculation results.

4. The method according to claim 2, wherein the index information of each of the plurality of plug-ins comprises at least one keyword related to the description text of the each of the plurality of plug-ins; and
wherein the matching the first dialogue text with the index information of each of the plurality of plug-ins to obtain a plurality of matching results comprises:
performing a keyword extraction on the first dialogue text to obtain a keyword related to the first dialogue text; and
matching the keyword related to the first dialogue text with at least one keyword related to the description text of each of the plurality of plug-ins to obtain the plurality of matching results.

5. The method according to claim 1, wherein determining the first target plug-in related to the first dialogue text contained in the human-computer interaction request from the plurality of plug-ins registered in the large language model based on the first dialogue text contained in the human-computer interaction request comprises:
determining, based on the first dialogue text, a plug-in type information related to the first dialogue text;
determining at least one second target plug-in from the plurality of plug-ins based on the plug-in type information;
acquiring an index information of each of the at least one second target plug-in from a plug-in information database;
matching the first dialogue text with the index information of each of the at least one second target plug-in to obtain at least one matching result; and
determining the first target plug-in from the at least one second target plug-in based on the at least one matching result.

6. The method according to claim 2, further comprising:
generating, in response to a plug-in registration request, an index information of a third target plug-in based on a description text of the third target plug-in contained in the plug-in registration request; and
writing the index information of the third target plug-in into the plug-in information database.

7. The method according to claim 1, wherein the obtaining a second dialogue text based on the first dialogue text and a description text of the first target plug-in comprises:
concatenating the description text of the first target plug-in into a context of the first dialogue text to obtain the second dialogue text.

8. The method according to claim 1, wherein the obtaining a second dialogue text based on the first dialogue text and a description text of the first target plug-in comprises:
filling the first dialogue text and the description text of the first target plug-in separately into a first prompt template to obtain the second dialogue text.

9. The method according to claim 8, wherein the first prompt template comprises a first text information slot and a plug-in information slot; and
wherein the filling the first dialogue text and the description text of the first target plug-in separately into a first prompt template to obtain the second dialogue text comprises:
filling the first dialogue text into the first text information slot, and filling the description text of the first target plug-in into the plug-in information slot, so as to obtain the second dialogue text.

10. The method according to claim 1, wherein the inputting the second dialogue text into the large language model to obtain a response text comprises:
inputting the second dialogue text into the large language model so that the large language model calls the first target plug-in based on the description text of the first target plug-in contained in the second dialogue text to process the first dialogue text contained in the second dialogue text to obtain the response text.

11. The method according to claim 1, wherein the inputting the second dialogue text into the large language model to obtain a response text comprises:
inputting the second dialogue text into the large language model so that the large language model calls the first target plug-in based on the description text of the first target plug-in contained in the second dialogue text to process the first dialogue text contained in the second dialogue text to obtain an initial response text;
filling the first dialogue text and the initial response text separately into a second prompt template to obtain a third dialogue text; and
inputting the third dialogue text into the large language model to obtain the response text.

12. The method according to claim 11, wherein the second prompt template comprises a second text information slot and a third text information slot; and
wherein the filling the first dialogue text and the initial response text separately into a second prompt template to obtain a third dialogue text comprises:
filling the first dialogue text into the second text information slot, and filling the initial response text into the third text information slot, so as to obtain the third dialogue text.

13. The method according to claim 1, wherein the plurality of plug-ins comprise at least one fourth target plug-in, and the at least one fourth target plug-in is marked as being in a selected state; and
wherein the method further comprises:
obtaining a fourth dialogue text based on the first dialogue text, the description text of the first target plug-in, and a description text of each of the at least one fourth target plug-in; and
inputting the fourth dialogue text into the large language model to obtain the response text.

14. The method according to claim 13, wherein the inputting the fourth dialogue text into the large language model to obtain the response text comprises:
inputting the fourth dialogue text into the large language model so that the large language model determines a fourth target plug-in from the first target plug-in and the at least one fourth target plug-in based on the fourth dialogue text; and
calling, by using the large language model, the fourth target plug-in based on the description text of the fourth target plug-in contained in the fourth dialogue text, so as to process the first dialogue text contained in the fourth dialogue text to obtain the response text.

15-28. (canceled)

29. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
determine, in response to a human-computer interaction request, a first target plug-in related to a first dialogue text contained in the human-computer interaction request from a plurality of plug-ins registered in a large language model based on the first dialogue text contained in the human-computer interaction request;
obtain a second dialogue text based on the first dialogue text and a description text of the first target plug-in; and
input the second dialogue text into the large language model to obtain a response text.

30. A non-transitory computer-readable storage medium having computer instructions therein, wherein the computer instructions are configured to cause a computer to at least:
determine, in response to a human-computer interaction request, a first target plug-in related to a first dialogue text contained in the human-computer interaction request from a plurality of plug-ins registered in a large language model based on the first dialogue text contained in the human-computer interaction request;
obtain a second dialogue text based on the first dialogue text and a description text of the first target plug-in; and
input the second dialogue text into the large language model to obtain a response text.

31. (canceled)

32. The electronic device according to claim 29, wherein the instructions are further configured to cause the at least one processor to at least:
acquire an index information of each of the plurality of plug-ins from a plug-in information database;
match the first dialogue text with the index information of each of the plurality of plug-ins to obtain a plurality of matching results; and
determine the first target plug-in from the plurality of plug-ins based on the plurality of matching results.

33. The electronic device according to claim 32, wherein the index information of each of the plurality of plug-ins comprises a feature vector of a description text of the each of the plurality of plug-ins; and
wherein the instructions are further configured to cause the at least one processor to at least:
perform a feature extraction on the first dialogue text to obtain a feature vector of the first dialogue text;
calculate a similarity between the feature vector of the first dialogue text and the feature vector of the description text of each of the plurality of plug-ins to obtain a plurality of similarity calculation results; and
obtain the plurality of matching results based on the plurality of similarity calculation results.

34. The electronic device according to claim 32, wherein the index information of each of the plurality of plug-ins comprises at least one keyword related to the description text of the each of the plurality of plug-ins; and
wherein the instructions are further configured to cause the at least one processor to at least:
perform a keyword extraction on the first dialogue text to obtain a keyword related to the first dialogue text; and
match the keyword related to the first dialogue text with at least one keyword related to the description text of each of the plurality of plug-ins to obtain the plurality of matching results.

35. The electronic device according to claim 29, wherein the instructions are further configured to cause the at least one processor to at least:
determine, based on the first dialogue text, a plug-in type information related to the first dialogue text;
determine at least one second target plug-in from the plurality of plug-ins based on the plug-in type information;
acquire an index information of each of the at least one second target plug-in from a plug-in information database;
match the first dialogue text with the index information of each of the at least one second target plug-in to obtain at least one matching result; and
determine the first target plug-in from the at least one second target plug-in based on the at least one matching result.
